(19) United States
(12) Patent Application Publication
(10) Pub. No.: US 2006/0028986 A1
(43) Pub. Date: Feb. 9, 2006

(54) Packet processing apparatus and method in a portable Internet system

(75) Inventors: Jae-Woo Kwon, Suwon-si (KR); Hong-Sung Chang, Suwon-si (KR); Nae-Hyun Lim, Yongin-si (KR); Jun-Hyuk Song, Anyang-si (KR); Jung-Shin Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/197,319

(22) Filed: Aug. 5, 2005

(30) Foreign Application Priority Data
Aug. 5, 2004 (KR) 2004-61838

(51) Int. Cl. H04L 12/26; H04L 12/56

(52) U.S. Cl. 370/230; 370/389; 370/395.21; 370/401

(57) ABSTRACT

Packet processing method and apparatus are provided in a portable Internet system, in which a base station of the portable Internet system is designed to have a number of connection processors and connection controllers. The number of mobile subscriber stations to which a single base station can provide service can be increased, and information necessary for providing a service to the mobile subscriber stations can be efficiently managed.

### CLAIM OF PRIORITY

This application claims benefit under 35 U.S.C. §119 from an application for Korean Patent Application Serial No. 2004-61838 filed in the Korean Intellectual Property Office on Aug. 5, 2004 the entire disclosure of which is hereby incorporated by reference.

### BACKGROUND OF THE INVENTION

1. Field of the Invention

The present invention relates to packet processing method and apparatus in a portable Internet system. More particularly, this invention relates to portable Internet systems which process packets in a base station of a separate structure that is designed to increase the number of mobile subscriber stations that can be processed by a single base station in a portable Internet system.

2. Description of the Related Art

A digital cellular portable communication system has improved channel capability and voice quality over an analog cellular portable communication system, providing voice and low-speed data services. However, the digital cellular portable communication system is still restricted from providing various multimedia services.

Owing to this restriction, International Mobile Telecommunication-2000 (IMT-2000) has been proposed with the aim to provide not only voice services but also multimedia services such as a high-speed data service on Internet and an image service.

At present, however, the cost of constructing such a portable communication system is high, and thus subscribers have to pay high fees for wireless Internet services. Besides, there still exist obstacles to provide various contents since existing terminals have a small-sized display unit. Accordingly, there are limitations in providing high-speed wireless Internet services.

Furthermore, even though wireless Local Area Network (LAN) technologies using existing ISM bandwidth can be applied to a home LAN in a small area, there are limitations in providing public services owing to radio wave interference and the like.

In order to overcome such limitations, a high-speed portable Internet system having a wider service cell area than a wireless LAN has been proposed. This system can support middle/low speed mobility as well as seamless services.

The portable Internet system is a system that intermediates between a wireless LAN and a wireless Internet based upon mobile communication to afford advantages of these services.

With such a portable Internet system, a user or subscriber can access the Internet at a maximum transmission rate of 50 Mbps in stationary indoor/outdoor environments or mobile environments such as walking and middle/low speed movement, by using various types of portable terminals such as a notebook computer, a PDA and a Handheld PC, to use various information and contents.

Available services of the portable Internet system may be classified into transmission services such as Internet access or connection, E-mailing and search, amusement services such as photograph transmission, VoDs and games and business services such as remote approval or payment and electronic commerce.

As wired and wireless networks are integrated, the mobility of personal terminals is improved, and communication technologies develop focused on speeding-up of data transmission and enhancing capability, it is expected that various application services will appear in the future.

Furthermore, since dynamic image-related services, Internet broadcast services and other services requiring massive database access technologies are expected, a next-generation mobile communication system will be able to transmit/receive data at a high speed of up to several hundreds Mbps by using 2 to 60 GHz bandwidth.

FIG. 1 is an overall block diagram for illustrating a portable Internet system.

Referring to FIG. 1, a number of Mobile Subscriber Station (MSS) 10 are connected to a Base Station (BS) 20, which is connected to an IP network 40 via a gateway 30.

The IP network 40 includes a server 50, which comprises a special purpose server such as an Authentication, Authorization and Accounting (AAA) server, a Home Agent (HA) server, a Dynamic Host Configuration Protocol (DHCP) server.

At initial booting up, each of the MSSs 10 accesses the BS 20, requesting registration. When registration is enabled via the BS 20, the MSS 10 transmits a service request message to the IP network 40 via user selection, and provides the user with a service according to a packet transmitted from the IP network 40.

The BS 20 serves to exchange messages with the MSSs 10 located in a corresponding service cell, authenticate and register the MSSs 10 via the server 50 in the IP network 40, and transmit service request messages from the MSSs 10 to the IP network 40 and packets from the IP network to the MSSs 10.

However, such a portable Internet system is restricted in the number of the MSSs 10 that a single BS 20 can handle via wireless connection.

Accordingly, it is necessary to be able to increase the number of the MSSs 10 that the single BS 20 can handle as well as to efficiently manage information necessary for the BS 20 to provide a service to the MSSs 10.

### SUMMARY OF THE INVENTION

The present invention has been made to address the foregoing problems of the prior art and it is therefore an object of the present invention to provide packet processing method and apparatus in a portable Internet system which can increase the number of MSSs in a portable Internet system, so that a single base station can provide a service as well as efficiently manage information by which a service can be provided to each MSS.

According to an exemplary aspect of the present invention for addressing the foregoing object, a packet processing method in a portable Internet system comprising at least one terminal, the method comprising transmitting session information to a corresponding connection processor upon receiving a packet from a network, setting session with the terminal according to the session information, and transmitting the session setup information to the connection controller, and transmitting the packet to the terminal via a session generated according to the session setup information.

According to another exemplary aspect of the present invention, a packet processing method in a portable Internet system comprising at least one terminal, the method comprising transmitting a traffic indication message to the connection processor upon receiving packet on the session state of sleep mode, transmitting a mode conversion request message to the terminal upon receiving the traffic message, converting session state to Awake mode upon receiving the mode conversion request message, transmitting session information to a corresponding connection processor, and setting session with the terminal according to the session information, and transmitting the packet through the session generated.

According to another exemplary aspect of the present invention, a packet processing method in a portable Internet system comprising at least one terminal, the method comprising transmitting a paging message containing paging-related information to the terminal via the connection processor upon receiving a packet in the idle mode of the terminal, converting to an awake mode upon receiving the paging message, and transmitting a connection information request message to the connection processor, allocating basic CID information and Primary Management CID information of the terminal, and setting basic capability information, providing registration information according to authentication procedure and subscriber information of the terminal, transmitting session information to a corresponding connection processor, and setting session with the terminal according to the session information, and transmitting the packet through the session generated.

According to another exemplary aspect of the present invention, a portable Internet system for providing Internet service to plurality of terminals comprising a connection controller adapted to, upon receiving a packet from a network, confirm service quality information of the terminal, classify the packet, transmit session information, and transmit the packet to the terminal via a session generated according to the session setup information, and at least one connection processor adapted to set a session with the terminal according to the session information from the connection controller and transmit the session setup information to the connection controller.

According to another exemplary aspect of the present invention, a packet processing method in a portable Internet system, which comprises at least one terminal, at least one connection processor and a connection controller internally connected with the connection processor, the method comprising transmitting to the connection processor an Hbis-Service Add Request message containing Service Flow (SF) information, Convergence Sublayer (CS) parameter information, Key information and IP address information upon receiving packet, allocating transport CID information to the terminal upon receiving the Hbis-Service Add message, and transmitting a Dynamic Service Addition Request (DSA-REQ) message containing SF information and CS parameter information to the terminal, transmitting a Dynamic Service Addition Response(DSA-RSP) message containing Confirmation Code information to the connection processor upon receiving the DSA-REQ message, transmitting an Hbis-Service Add Response containing Confirmation Code information, SF information, CS parameter result value, Key information, IP address information and transport CID information to connection controller, transmitting an Hbis-Service Confirm message in order to notify whether or not generation of a session to the connection processor, transmitting a Dynamic Service Addition Acknowledge (DSA-ACK) message in order to notify whether or not session generation is succeeded to the terminal upon receiving the Hbis-Service Confirm message, and transmitting the packet to the terminal via the generated session if the generation is succeeded.

### BRIEF DESCRIPTION OF THE DRAWINGS

The above and other objects, features and other advantages of the exemplary embodiments of the present invention will be more clearly understood from the following detailed description taken in conjunction with the accompanying drawings, in which like reference symbols indicate the same or similar components, wherein:

FIG. 1 is an overall block diagram for illustrating a portable Internet system;

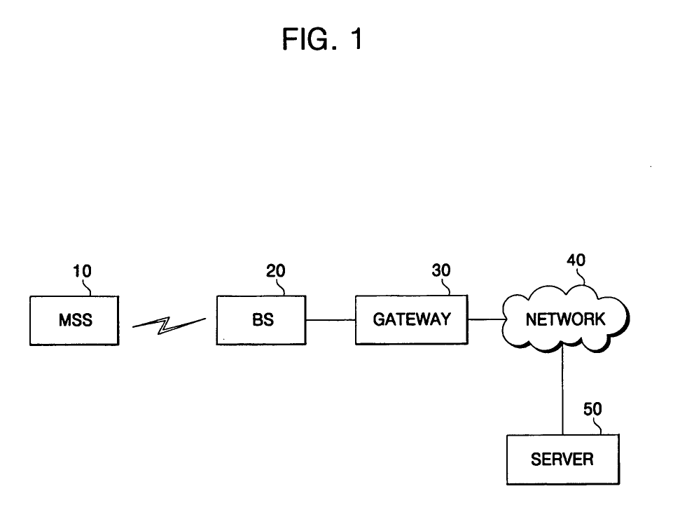

FIG. 2 is an overall block diagram for illustrating a portable Internet system according to an exemplary embodiment of the present invention;

FIG. 3 is an internal block diagram for illustrating an AP according to an exemplary embodiment of the present invention;

FIG. 4 is a conceptual view for illustrating functions carried out by an AP according to an exemplary implementation of the present invention;

FIG. 5 is an internal block diagram for illustrating an APC according to an exemplary embodiment of the present invention;

FIG. 6 is a conceptual view for illustrating functions carried out by an APC according to an exemplary implementation of the invention;

FIG. 7A is a flowchart for illustrating message flows in an Awake mode in a portable Internet system according to an exemplary embodiment of the present invention;

FIG. 7B is a flowchart for illustrating message flows in a sleep mode of a portable Internet system according to an exemplary embodiment of the present invention;

FIG. 7C is a flowchart for illustrating message flows in an Idle mode of a portable Internet system according to an exemplary embodiment of the present invention;

FIG. 8 is a flowchart for illustrating a message processing method in an Awake mode of a portable Internet system according to an exemplary embodiment of the present invention;

FIG. 9 is a flowchart for illustrating a message processing method in a Sleep mode of a portable Internet system according to an exemplary embodiment of the present invention; and

FIG. 10 is a flowchart for illustrating a message processing method in an Idle mode of a portable Internet system according to an exemplary embodiment of the present invention.

### DETAILED DESCRIPTION OF EXEMPLARY EMBODIMENTS

The following detailed description sets forth exemplary implementations of an apparatus and a method for processing packet in a portable Internet system according to the present invention with reference to the accompanying drawings.

It is also to be understood that, as noted above, the same reference numbers are used to designate the same or similar components throughout different drawings.

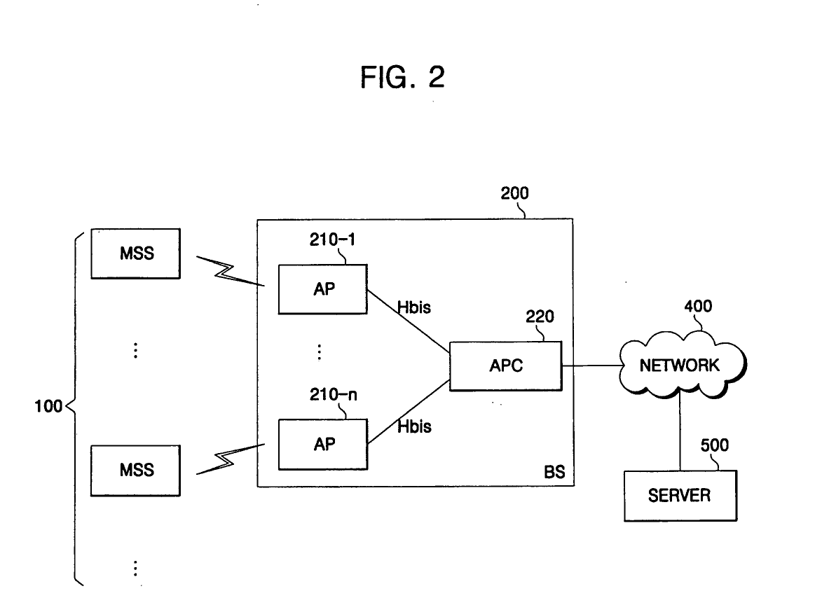

FIG. 2 is an overall block diagram for illustrating a portable Internet system according to an exemplary embodiment of the present invention.

Referring to FIG. 2, an exemplary implementation of the portable Internet system of the present invention includes a number of MSSs 100, a BS 200 wirelessly connected to the MSSs 100 and a server 500 connected to the BS 200 via an IP network 400.

The server 500 may comprise at least one of an AAA server, an HA server, a DHCP server and so on.

The AAA server functions to process authentication, authorization and accounting to each MSS 100 connected via the IP network 400.

The HA server processes routing of mobile IP address information and a packet of the MSS 100, which accesses the HA server 500 via the IP network 400, to support the mobility of the MSS 100.

The DHCP server allocates IP address to be used in the IP network 400 to each MSS 100 connected via the IP network 400.

The BS 200 includes a plurality of APs 210 and an APC 220 connected to the APs 210 via internal interfaces (hereinafter will be referred to as ‘Hbis interface’).

Each of the MSSs 100 is wirelessly connected to the APC 220 that covers the current location of the MSS 100 as a service cell. The MSS 100 receives a message transmitted from the BS 200 at initial connection, wirelessly scans a corresponding one of the APs 210 to be connected, and acquires parameters for tuning to down link and up link channels. Examples of the message may include a Down Channel Descriptor (DCD) message, a Down Link MAP (DL-MAP) message, an Up Channel Descriptor (UCD) message, an Up Link MAP (UL-MAP) message and the like.

If packet exchange has not taken place for a predetermined time period, the MSS 100 converts to a sleep or idle mode while transmitting a mode conversion request message to the BS 200.

Upon receiving a mode conversion command message from the BS 200, the MSS 100 converts to an Awake mode and sets a session for exchanging packets with the IP network.

When the MSS 100 is initially connected, the BS 200 allocates basic Connection Identifier (CID) and primary CID information to the MSS 100 and transmits a reply message in response to a request message from the MSS 100.

Each of the APs 210 of the BS 200 forms a Protocol Data Unit (PDU) according to a MAC header and a MAC subheader, authenticates the PDU having management CID, and processes coding to the PDU having transport CID.

The AP 210 allocates and manages a Generic Route Encapsulation (GRE) header tunnel key, processes a message, which is exchanged through an Hbis interface connected to the APC 220, and allocates and manages connection ID in use for exchanging a message with the APC 220.

The AP 210 generates a MAC header and a MAC subheader according to information included in a message transmitted from the APC 220, enabling a PDU to be formed, and processes routing for a packet received via a physical layer.

The APC 220 classifies packets, compresses packet headers, and exchanges messages with the APs 210 via an Hbis interface.

That is, the APC 220 generates and transmits a reply message in response to a request message from the APs 210, allocates and manages Service Flow (S/F) ID and GRE tunnel key information, and manages privacy key information transmitted from the server 500 via the IP network 400.

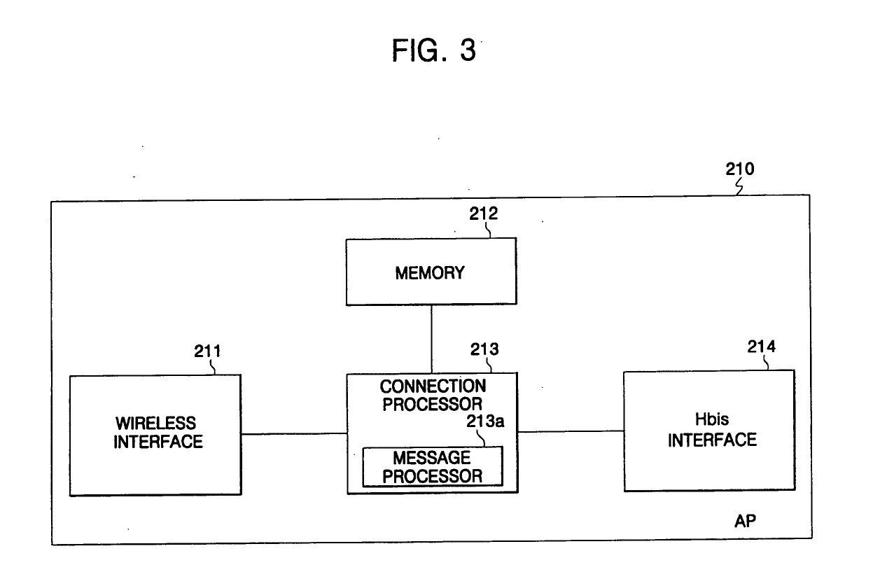

FIG. 3 is an internal block diagram for illustrating the AP according to an exemplary embodiment of the present invention.

Referring to FIG. 3, the AP 210 includes a wireless interface 211, a connection processor 213, a memory 212 and an Hbis interface 214, in which the connection processor 213 includes a message processor 213a.

The wireless interface 211 receives a request message from an MSS 100 via a wireless link, and transmits a reply message from the AP 210 to the MSS 100.

The memory 212 stores operating program information of the AP 210, parameter information allowing the memory 212 to exchange a message with the MSS 100 via the wireless link, and CID information allocated to the MSS 100.

The Hbis interface 214 transmits an Hbis message, which is generated by the AP 210, to the APC 220 via the Hbis interface, and receives an Hbis message transmitted from the APC 220.

The connection processor 213 generates a reply message in response to a request message transmitted from the MSS 100, and generates an Hbis message in use for reporting information allocated to the MSS 100 to the APC 220.

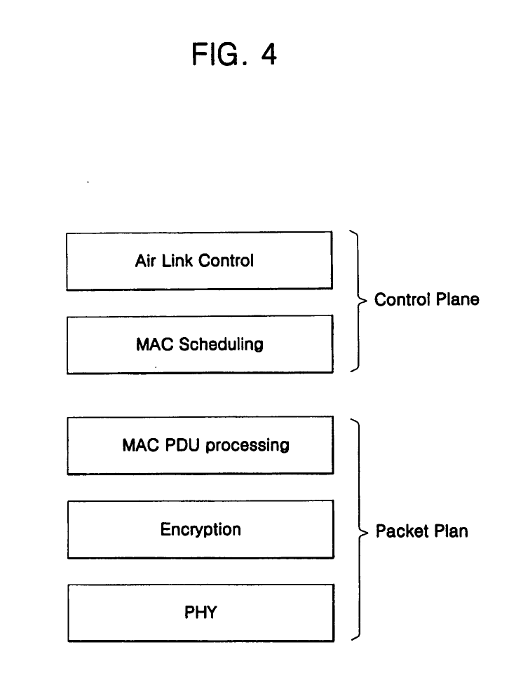

FIG. 4 is a conceptual view for illustrating functions carried out by an AP according to an exemplary implementation of the present invention.

Referring to FIG. 4, the functions of the AP 210 according to exemplary implementation of the present invention may be generally grouped into packet and control plan aspects. In the packet plan aspect, the AP 210 carries out Physical (PHY), encryption, MAC PDU processing functions. In the packet plan aspect, the AP 210 carries out MAC scheduling and wireless control functions.

The encryption function is carried out to authenticate a PDU having management CID, encrypt a PDU having transport CID, and maintain Security Association (SA) with the APC 220.

The MAC PDU processing function is carried out to constitute a PDU by using a MAC header and a MAC subheader, and includes fragmentation and packing.

In addition, as the MAC scheduling function, the AP 210 generates a MAC header and a MAC subheader for a down link packet according to packet scheduling and Hbis interface information connected to the APC 220, and transmits a packet to the IP network 400 according to an up link.

In an exemplary implementation, packet transmission via the up link corresponds to any of Unsolicited Grant Service (UGS), real-time Polling Service (rtPS), non-real-time Polling Service (nrtPS) and Best Effort (BE) scheduling.

As the air link control function, the AP 210 processes a MAC management message, generates an Hbis request message to be exchanged with the APC 220 via the Hbis interface so that the AP 210 can exchange signaling information with the APC 220 by using the Hbis message, and allocates and manages connection ID information and GRE tunnel key information.

That is, the AP 210 authenticates and encodes a received PDU and exchanges registration information, which is necessary for providing a service to the MSS 100, with the APC 220 by using the Hbis message.

The message processor 213a of the connection processor 213 periodically generates and transmits DCD, DL-MAP, UCD and UL-MAP messages to the APC 220 at the initial connection of the MSS 100. The message processor 213a also generates and transmits an Hbis request message to the APC 220 in response to a request message received from the MSS 100.

The message processor 213a stores parameter information of an Hbis reply message received from the APC 220 into the memory 212, or generates and transmits a reply message containing parameter information to the MSS 100.

If there is a packet to be transmitted to the MSS 100 in a sleep or idle mode, the message processor 213a transmits a mode conversion command message to convert the MSS 100 to an awake mode.

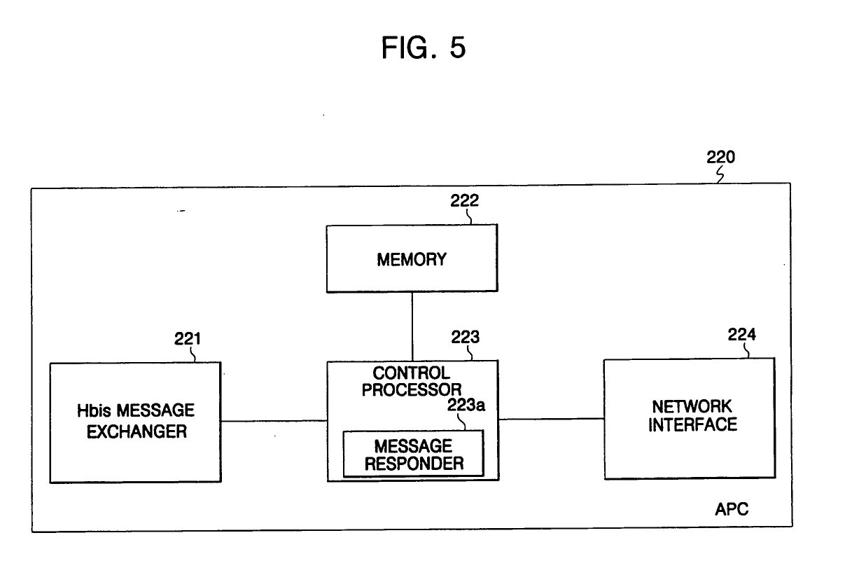

FIG. 5 is an internal block diagram for illustrating the APC according to an exemplary embodiment of the present invention.

Referring to FIG. 5, the APC 220 according to an exemplary implementation of the invention includes an Hbis message exchanger 221, a control processor 223, a network interface 224 and a memory 222, in which the control processor 223 includes a message responder 223a.

The Hbis message exchanger 221 receives an Hbis request message transmitted from the AP 210 via the Hbis interface, and transmits an Hbis reply message generated by the APC 220 to a corresponding one of the APs 210.

The control processor 223 transmits a request message to the server 500, which is connected via the network, in response to an Hbis message received via the Hbis message exchanger 221. The control processor 223 also transmits an Hbis reply message to the AP 210, in which the Hbis reply message is provided according to registration information or authentication information provided by the server 500.

The network interface 224 transmits a request message generated by the control processor 223 to the server 500 via the IP network, and information provided by the server 500 to the control processor 223.

In an exemplary implementation, the network interface 224 has a gateway function so that a request message generated by the control processor 223 can be transmitted to the server 500 via the IP network 400.

In an exemplary implementation, the message responder 223a of the control processor 223 generates a request message in response to an Hbis request message transmitted from the AP 210 to transmit the request message to the server 500, or generates an Hbis reply message containing registration or authentication information provided by the server 500 to transmit the Hbis reply message to the AP 210.

When a packet to be transmitted to the MSS 100 is received from the IP network, the control processor 223 generates and transmits an internal service request message to the AP 210, and when a session is set between the APC 220 and the MSS 100, transmits the packet to the MSS 100.

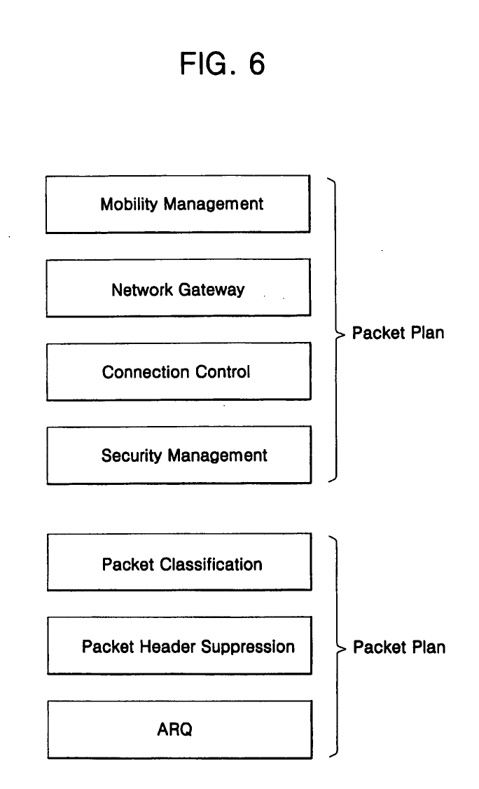

FIG. 6 is a conceptual view for illustrating functions carried out by an APC according to an exemplary implementation of the present invention.

Referring to FIG. 6, the APC 220 of the invention processes Automatic Repeat Request (ARQ) and Packet Classification function in a packet plan aspect, and Security Management, Connection Control, Network Gateway and Mobility Management functions in a control plan aspect.

The ARQ function is such that the APC 220 exchanges a subheader with each of the APs 210 via the Hbis interface in order to process ARQ.

The Packet Header Suppression function is to compress a header of a packet, the packet classification function is to classify and map a received packet according to a Service Flow (S/F).

The security management function is to manage privacy key information provided from the server 500, the Connection Control function is to exchange signaling information via the Hbis interface connected to the AP 210 as well as to allocate/manage service flow ID information and GRE tunnel key information.

The Network Gateway function is to authenticate received packets, and enables the APC 220 to match with the server 500 via the network.

In an exemplary implementation, the message responder 223a of the control processor 223 stores parameters contained in a Hbis request message received from the AP 210, or generates and transmits a request message to the server 500.

The message responder 223a transmits an Hbis reply message containing authentication-related information or registration information provided from the server 500 to the AP 210.

The Hbis message exchanged between the AP 210 and the APC 220 may have a structure as follows:

```
  Hbis Signaling Message Format
{
  Hbis Message Type
  Length
  AP/APC Job ID
  Mandatory field
  TLV-encoded Information Element
}
```

In an exemplary implementation, the Hbis message exchanged between the AP 210 and the APC 220 can be used to exchange parameter information via ‘Mandatory field’ and ‘TLV-encoded Information Element’ areas.

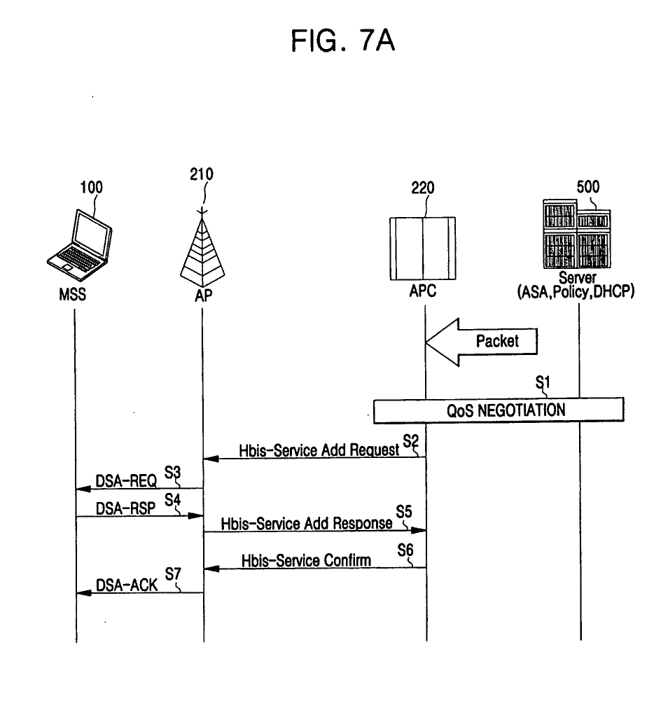

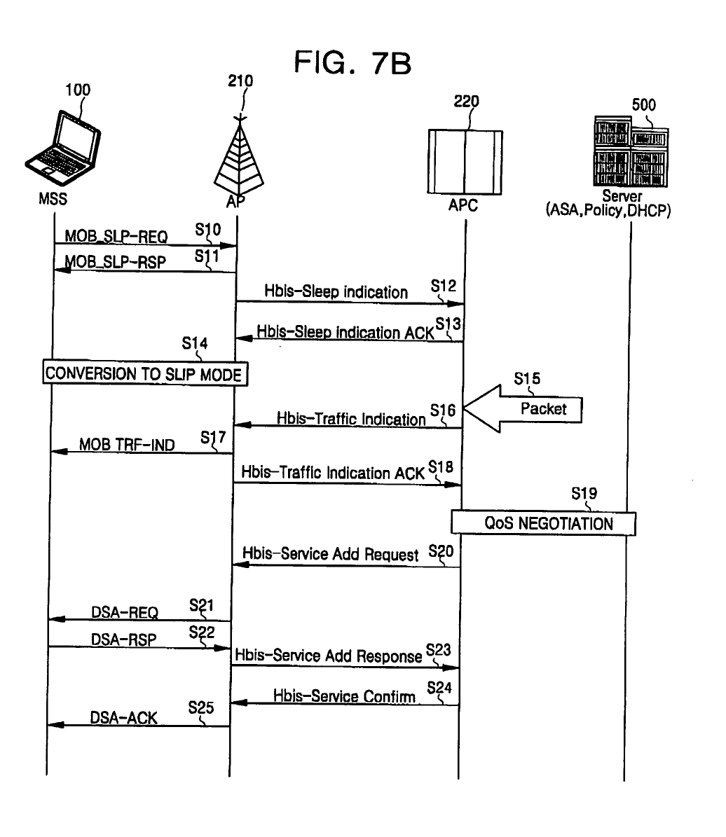

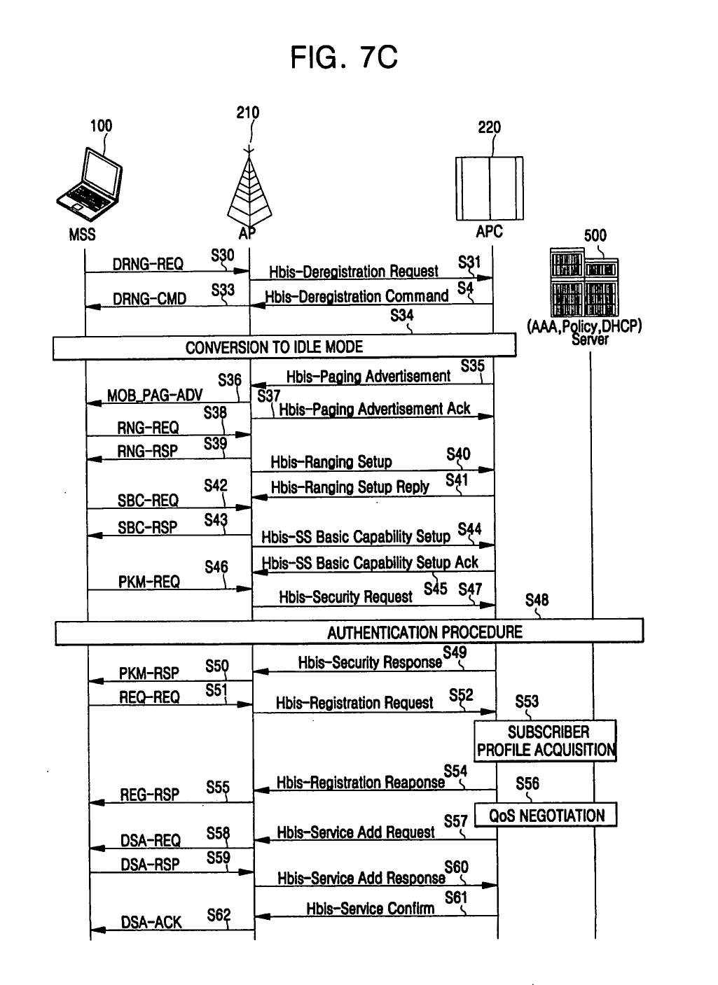

FIG. 7A is a flowchart for illustrating message flows in an Awake mode in a portable Internet system according to an exemplary embodiment of the present invention.

Referring to FIG. 7A, the APC 220, upon receiving a packet from the IP network which is to be transmitted to the MSS 100, confirms QoS policy information about the policy server 500 and the MSS 100 in S1.

Then, the APC 220 classifies the received packet according to the confirmed QoS policy information of the MSS 100.

In S2, the APC 220 allocates service ID for packet transmission, and transmits an Hbis-Service Add Request message to the AP 210 in order to set a session by which the packet is to be transmitted. The Hbis-Service Add Request message contains Service Flow (SF) and Convergence Sublayer (CS) parameter information, GRE Tunnel Key information for packet tunneling between the APC 220 and the AP 210 and IP address information.

Table 1 below illustrates parameters of the Hbis-Service Add Request message.

The definition of the parameters contained in the message described below will not be described in detail since it is specified in “IEEE 802.16d.”

TABLE 1

| Name | | Description | | |
|---|---|---|---|---|
| Message Type | | | | |
| Length | | | | |
| AP/APC Job ID | | | | |
| Transaction ID | | | | |
| GRE Tunnel Key | | Traffic Tunnel Key between AP and APC | | |
| IP Address | | (AP/APC) IP address (for Tunnel) | | |
| IE Name | | T | L | Value |
| Service | Service Flow Identifier (SFID) | | | |
| Flow | Service Class name | | | |
| Parameters | QoS Parameter Set Type | | | Provisioned Set, Admitted Set, Active |
| | | | | Set |
| | Traffic Priority | | | |
| | Maximum Sustained Traffic Rate | | | |
| | Maximum Traffic Burst | | | |
| | Minimum Reserved Traffic Rate | | | |
| | Minimum Tolerable Traffic Rate | | | |
| | Service Flow Scheduling Type | | | |
| | Request/Transmission Policy | | | |
| | Tolerated Jitter | | | |
| | Maximum Latency | | | |
| | Fixed-length versus Variable- | | | Used only if packing is on for the |
| | length SDU Indicator | | | service flow |
| | SDU size | | | |
| | Target SAID | | | |
| | ARQ TLVs for ARQ-enabled | | | |
| | connection | | | |
| CS | CS Specification | | | IPv4, IPv4 over 802.3, ATM, etc |
| Parameter | Classifier rule priority | | | The priority for the Classifier |
| Encodings | IP TOS/DSCP range and mask | | | |
| | Protocol | | | Protocol field in IP header |
| | IP masked source address | | | IP addresses and their corresponding |
| | | | | address masks |
| | ID destination add | | | |
| | Protocol source port range | | | |
| | Protocol destination port range | | | |
| | Ethernet destination MAC address | | | |
| | Ethernet source MAC address | | | |
| | Ethertype/IEEE802.2-1998 SAP | | | |
| | IEEE 802.1D-1998 User_Priority | | | |
| | IEEE 802.1A-1998 VLAN_ID | | | |
| | Associated PHSI | | | |
| | Packet Classifier Rule Index | | | |
| | Vendor-specific classifier | | | |
| | parameters | | | |
| | PHS DSC action | | | |
| | PHS error parameter set | | | |
| | PHS Rule | | | PHSI, PHSF, PHSM, PHSS, PHSV |
| | IPv6 Flow label | | | |

As set forth in Table 1 above, the APC 220 can transmit SF/CS parameter information and GRE and IP address information for packet tunneling with the AP 210 via the Hbis-Service Add Request message.

In S3, the AP 210, upon receiving the Hbis-Service Add from the APC 220, allocates transport CID information to the MSS 100, and transmits a Dynamic Service Addition Request (DSA-REQ) message containing SF/CS parameter information to the MSS 100.

The MSS 100, upon receiving the DSA-REQ message from the AP 210, transmits a Dynamic Service Addition Response (DSA-RSP) message containing Confirmation Code information and requested SF/CS parameter result value to the AP 210 in S4.

The AP 210 transmits a Hbis-Service Add Response to the APC 220 in S5. The Hbis-Service Add Response contains Confirmation Code information transmitted from the MSS 100 via the DSA-RSP message, requested SF/CS parameter result value, Tunnel Key information for packet tunneling between the AP 210 and the APC 220, IP address information and allocated transport CID information.

Table 2 below shows parameters of the Hbis-Service Add Response message that the AP 210 transmits.

TABLE 2

| Name | | Description | | |
|---|---|---|---|---|
| Transaction ID | | | | |
| GRE Tunnel Key | | Traffic Tunnel Key between AP and APC | | |
| IP Address | | (AP/APC) IP address (for Tunnel) | | |
| IE Name | | T | L | Value |
| Confirmation Code | | | Sources | |
| Service | Service Flow Identifier (SFID) | | | |
| Flow | Service Class name | | | |
| Parameters | QoS Parameter Set Type | | | Provisioned Set, Admitted Set, |
| | | | | Active Set |
| | Traffic Priority | | | |
| | Maximum Sustained Traffic Rate | | | |
| | Maximum Traffic Burst | | | |
| | Minimum Reserved Traffic Rate | | | |
| | Minimum Tolerable Traffic Rate | | | |
| | Service Flow Scheduling Type | | | |
| | Request/Transmission Policy | | | |
| | Tolerated Jitter | | | |
| | Maximum Latency | | | |
| | Fixed-length versus Variable- | | | |
| | length SDU Indicator | | | |
| | ARQ TLVs for ARQ-enabled | | | |
| | connection | | | |
| CS | CS Specification | | | IPv4, IPv4 over 802.3, ATM, etc |
| Parameter | Classifier rule priority | | | The priority for the Classifier |
| Encodings | IP TOS/DSCP range and mask | | | |
| | Protocol | | | Protocol field in IP header |
| | IP masked source address | | | IP address and their |
| | | | | corresponding address |
| | ID destination address | | | |
| | Protocol source port range | | | |
| | Protocol destination port range | | | |
| | Ethernet destination MAC address | | | |
| | Ethernet source MAC address | | | |
| | Ethertype/IEEE802.2-1998 SAP | | | |
| | IEEE 802.1D-1998 User_Priority | | | |
| | IEEE 802.1A-1998 VLAN_ID | | | |
| | Associated PHSI | | | |
| | Packet Classifier Rule Index | | | |
| | Vendor-specific classifier | | | |
| | parameters | | | |
| | PHS DSC action | | | |
| | PHS error parameter set | | | |
| | PHS Rule | | | PHSI, PHSF, PHSM, PHSS, |
| | | | | PHSV |
| | IPv6 Flow label | | | |

As set forth in Table 2 above, the AP 210 can transmit Confirmation Code information, requested SF/CS parameter result value, Tunnel Key information for packet tunneling with the APC, IP address information and allocated transport CID information via the Hbis-Service Add Response message.

In S6, the APC 220 transmits an Hbis-Service Confirm message to the AP 210 in order to notify whether or not generation of a session for transmitting a packet is succeeded.

Table 3A below shows parameters of an Hbis-Service Confirm message that the APC 220 transmits where session generation is succeeded.

TABLE 3a

| Name | Description | | |
|---|---|---|---|
| Message Type | | | |
| Length | | | |
| AP/APC Job ID | | | |
| Transaction ID | | | |
| IE Name | T | L | Value |
| Confirmation Code | | | Reject-(reasons) |

As set forth in Table 3a above, the APC 220 can notify the AP 210 that a session for transmitting a packet is generated, via the Hbis-Service Confirm message.

Table 3b below shows parameters of an Hbis-Service Confirm message that the APC 220 transmits where session generation has not succeeded.

TABLE 3b

| Name | Description | | |
|---|---|---|---|
| Message Type | | | |
| Length | | | |
| AP/APC Job ID | | | |
| Transaction ID | | | |
| IE Name | T | L | Value |
| Confirmation Code | | | Reject-(reasons) |
| CS Classifier error parameter | | | Errored parameter, Error code, |
| set | | | Error message |

As reported in Table 3b above, the APC 220 can notify the AP 210 that a session for transmitting a packet is not generated, via the Hbis-Service Confirm message.

In S7, the AP, upon receiving the Hbis-Service Confirm message, transmits a Dynamic Service Addition Acknowledge (DSA-ACK) message to the MSS 100 in order to notify any acknowledgment of the DSA-RSP message and whether or not service generation is succeeded.

FIG. 7B is a flowchart for illustrating message flows in a sleep mode of a portable Internet system according to a preferred embodiment of the invention.

Referring to FIG. 7B, if packet exchange has not taken place for a predetermined time period, the MSS 100 transmits an MOB_SLP-REQ message containing sleep mode-related parameter information to the AP 210 in order to convert to a Sleep mode in S10.

The AP 210, upon receiving the MOB_SLP-REQ message from the MSS 100, transmits an MOB_SLP-RSP message to the MSS 100 in S11. The MOB_SLP-RSP message contains result information about whether or not the MSS 100 accepts the Sleep mode and about related parameter information.

The AP 210 transmits a Hbis-sleep Indication message to the APC 210 for notifying the MSS 100 which is converted to the Sleep mode in S12.

The APC 220, upon receiving a Hbis-sleep Indication message successfully from the AP 210, transmits a Hbis-sleep Indication ACK message to the AP 210 in S13.

In S14, the session status of the MSS 100 is converted to the Sleep mode.

In a situation that the session status is converted to the sleep mode, the APC 220, upon receiving a packet to be transmitted to the MSS 100, confirms QoS policy information about the MSS 100 from the server 500 in S15.

The APC 220 transmits a Hbis-Traffic Indication message to the AP 210 for notifying that the APC 220 has the packet in S16.

The AP 210, upon receiving a Hbis-Traffic Indication message from the APC 220, transmits MOB_TRF-IND message to the MSS 100 for converting the MSS 100 to Awake mode, because the session state of the MSS 100 is Sleep mode.

The AP 210 transmits a Hbis-Traffic Indication ACK message to the APC 220 for notifying that the session state of the MSS 100 is converted to Awake mode.

The APC 220 also classifies the received packet according to QoS policy information and allocates service ID information of the MSS 100 in S119.

In S20, the APC 220 transmits an Hbis-Service Add Request message to the AP 210 in order to set a session for packet transmission. The Hbis-Service Add Request message contains SF/CS parameter information, Tunnel Key information for packet tunneling between the APC 220 and the AP 210 and IP address information.

In S21, the AP 210, upon receiving the Hbis-Service Add Request message from the APC 220, transmits an MOB_TRF-IND message for converting the MSS 100 from the sleep mode into an Awake mode.

Also, the AP 210 allocates transport CID to the MSS 100 and transmits a DSA-REQ message containing SF/CS parameter information to the MSS 100 in S22.

The MSS 100, upon receiving the DSA-REQ message from the AP 210, transmits a DSA-RSP message containing Confirmation Code information and requested SF/CS parameter result value to the AP 210 in S23.

In S24, the AP 210, upon receiving the DSA-RSP message, transmits an Hbis-Service Add Response message to the APC 220. The Hbis-Service Add Response message contains Confirmation Code information and requested SF/CS parameter result value, Tunnel Key information for packet tunneling between the AP 210 and the APC 220, IP address information and allocated transport CID information.

Then, the APC 220 transmits an Hbis-Service Confirm message to the AP 210, for notifying whether or not a session for transmitting a packet is successfully generated in S25.

In S21, the AP 210 transmits a DSA-ACK message for notifying whether or not session generation is succeeded to the MSS 100.

The APC, upon generation of a session for packet transmission, transmits a received packet to the MSS 100 via the session.

FIG. 7C is a flowchart for illustrating message flows in an Idle mode of a portable Internet system according to an exemplary embodiment of the present invention.

Referring to FIG. 7C, if packet exchange has not taken place for a predetermined time period, the MSS 100 transmits a De/RE-register Command Request (DREG-REQ) message to the AP 210 in order to convert to an Idle mode in S30.

In S31, the AP, upon receiving the DREG-REQ message from the MSS 100, transmits an Hbis-Deregistration Request message containing Deregistration Request Code information to the APC 220.

Table 4 below shows parameters of the Hbis-Deregistration Request message that the AP transmits.

TABLE 4

| Name | Description | | |
|---|---|---|---|
| Message Type | | | |
| Length | | | |
| AP/APC Job ID | | | |
| De-registration Request Code0x00 = MSS de- | | | |
| registration request for de-registration from BS | | | |
| IE Name | T | L | Value |
| Paging Cycle Request | | | |

As set forth in Table 4 above, the APC 220 can transmit Deregistration Request Code information via the Hbis-Deregistration Request message.

In S32, the APC 220 transmits an Hbis-Deregistration Command message containing Action Code parameter information and Paging-related parameter information.

Table 5 below shows parameters of the Hbis-Deregistration Command message that the APC 220 transmits.

TABLE 5

| Name | Description | | |
|---|---|---|---|
| Message Type | | | |
| Length | | | |
| AP/APC Job ID | | | |
| Action Code | If Action Code = 0x05, | | |
| | Paging Group ID, PAGING_CYCLE, and | | |
| | PAGING_OFFSET parameters to be used by the MSS | | |
| | in Idle Mode | | |
| IE Name | T | L | Value |
| Paging | | | |
| Information | | | |
| REQ-duration | | | |

As set forth in Table 5 above, the APC 220 can transmit Action Code parameter information and Paging-related parameter information via the Hbis-Deregistration Command message.

In S33, the AP 210 transmits a DREG-CMD message to the MSS 100, in which the DREG-CMD message contains Action Code parameter information and Paging-related parameter information received via the Hbis-Deregistration Command message.

In addition, the MSS is converted to an Idle mode in S34.

In S35, the APC 220, upon receiving a packet to be transmitted to the MSS 210 from the IP network, transmits an Hbis-Paging Advertisement message containing MAC address information and Paging Group ID information to the AP 100.

Table 6 below shows parameters of the Hbis-Paging Advertisement message that the APC 220 transmits.

TABLE 6

| Name | Description |
|---|---|
| Message Type | |
| Length | |
| AP/APC Job ID | |
| Paging Information | Paging Group ID, PAGING_CYCLE, and |
| | PAGING_OFFSET parameters to be used by the |
| | MSS in Idle Mode |
| SS MAC address | |
| Action Code | |

As set forth in Table 6 above, the APC 220 can transmit Paging Group ID information and MAC address information of the MSS 100 via the Hbis-Paging Advertisement message.

In S36, since the MSS 100 is in an Idle mode, the AP 210 converts the MSS 100 to an Awake mode by transmitting an MOB_PAG-ADV message.

In S37, in response to the received Hbis-Paging Advertisement message, the AP 210 transmits an Hbis-Paging Advertisement Ack message to the APC 220.

When the MSS 100 is converted to the Awake mode, the MSS 100 transmits an RNG-REQ message containing MAC address information and Serving BS ID information to the AP 210 in S38.

In this case, the MSS 100 can transmit the RNG-REQ message to the AP 210, by using initial Ranging CID.

In S39, the AP 210 allocates Basic CID and Primary Management CID to the connecting MSS 100, and upon receiving an RNG-REQ message from the MSS 100, transmits an RNG-RSP message containing allocated Basic CID and Primary Management CID.

In S40, the AP 210 generates an Hbis-Ranging Setup message containing Basic CID and Primary Management CID allocated to the MSS 100 and transmits the Hbis-Ranging Setup message to the APC 220.

Table 7 below shows parameters contained in the Hbis-Ranging Setup message that the AP 210 transmits.

TABLE 7

| Name | Description | | |
|---|---|---|---|
| Message Type | | | |
| Length | | | |
| AP(210)/APC(220) Job ID | | | |
| Basic CID | | | |
| Primary Management CID | | | |
| IE Name | T | L | Value |
| SS MAC Address | | | |
| MAC Version | | | |

As set forth in Table 7 above, the AP 210 can transmit Basic CID and Primary Management CID to the APC 220 via the Hbis-Ranging Setup message.

In this case, the AP 210 transmits the Hbis-Ranging Setup message to the APC 220, by using User Data Protocol (UDP) port number and default IP address of the APC 220.

The APC 220 provides a signaling path in use for the exchange of signaling messages to the MSS 100 according to set default IP address and UDP port number.

In S41, the APC 220 generates and transmits an Hbis-Ranging Setup Reply message to the AP 210, in which the Hbis-Ranging Setup Reply message contains IP address information and UDP port number information in use for a path of the Hbis message according to allocated Basic CID information and Primary CID information.

Table 8 below shows parameters of the Hbis-Ranging Setup Reply message that the APC transmits.

TABLE 8

| Name | Description |
|---|---|
| Message Type | |
| Length | |
| AP(210)/APC(220) Job ID | |
| IP Address | (for Basic and Primary Management CID) |
| Port | (for Basic and Primary Management CID) |

As set forth in Table 8 above, the APC 220 can transmit IP address information and UDP port information to the AP 210 via the Hbis-Ranging Setup Reply message.

Table 9 below shows parameters in a situation that the APC 220 transmits the Hbis-Ranging Setup Reply message containing serving BS-ID.

TABLE 9

| Name | Description | | |
|---|---|---|---|
| Message Type | | | |
| Length | | | |
| AP(210)/APC(220) Job ID | | | |
| IP Address | (for Basic and Primary Management CID) | | |
| Port | (for Basic and Primary Management CID) | | |
| IE Name | T | L | Value |
| Service Level Prediction | | | |
| Global Service Class Name | | | |
| QoS Parameters Set | | | |
| SFID | | | |
| Resource Retain Flag | | | |

As set forth in Table 9 above, the APC 220 can transmit the Hbis-Ranging Setup Reply message containing parameter information according to serving BS-ID information via parameters (IE Name) that can be added in the form of Type Length Value (TLV).

In S42, the MSS 100 transmits an SS Basic CAP(210)ability Request (SBC-REQ) message to the AP 210. The SB C-REQ message contains physical layer parameter information and authentication policy information supported by the MSS 100.

In S43, the AP 210 generates an SS Basic CAP(210)ability Repose (SBC-RSP) message by setting parameter value common in physical layer parameter and authentication policy information, which is contained in the SBC-REQ message received from the MSS 100, and parameter information of the AP 210, and transmits the SBC-RSP message to the MSS 1100.

The AP 210 generates and transmits an Hbis-SS Basic CAP(210)ability Setup message containing Basic CAP(210)ability information of the MSS 100 to the APC 220 in S44.

Table 10 below shows parameters of the Hbis-SS Basic CAP(210)ability Setup message that the AP 210 transmits.

TABLE 10

| Name | | Description | | |
|---|---|---|---|---|
| Message Type | | | | |
| Length | | | | |
| AP(210)/APC(220) Job ID | | | | |
| IE Name | | T | L | Value |
| Physical | Subscriber transition gAP(210)s | | | |
| Parameter | Maximum transmit power | | | |
| Supported | Current transmit power | | | |
| | OFDMA SS FFT sizes | | | |
| | OFDMA SS demodulator | | | 64-QAM, BTC, CTC, AAS, H-ARQ |
| | OFDMA SS modulator | | | |
| | The number of H-ARQ ACK | | | |
| | channel | | | |
| | OFDMA SS Permutation support | | | PUSC, FUSC, AMC |

Authorization Policy Support

As set forth in Table 10 above, the AP 210 can transmit Basic CAP(210)ability information of the MSS 100 via the Hbis-SS Basic CAP(210)ability Setup message.

In S45, the APC 220 stores Basic CAP(210)ability information contained in the Hbis-PSS Basic CAP(210)ability Setup message in the memory 222, and generates and transmits an Hbis-PSS Basic CAP(210)ability Setup Ack message to the AP 210.

Table 11 below shows parameters of an Hbis-PSS Basic CAP(210)ability Setup Ack message that the APC 220 transmits.

TABLE 11

| Name | Description |
|---|---|
| Message Type | |
| Length | |
| AP(210)/APC(220) Job ID | |

As set forth in Table 11 above, the APC 220 can notify the AP 210 that Basic CAP(210)ability contained in the Hbis-PSS Basic CAP(210) ability Setup message is received via the Hbis-PSS Basic CAP(210)ability (Setup Ack) message.

In S46, the MSS 100 generates and transmits a Privacy Key Management Request (PKM-REQ) message to the AP 210 for the purpose of connection authentication.

The type of the PKM-REQ message that the MSS 100 transmits can be one of Authorization Request, Key Request, EAP(210) Transfer Request and so on.

In S46, the AP 210, upon receiving the PKM-REQ message from the MSS 100, generates and transmits an Hbis-Security Request message to the APC 220, requesting authentication-related parameter information of the MSS 100.

Table 12 below shows parameters of the Hbis-Security Request message that the AP 210 transmits.

TABLE 12

| Name | Description | | |
|---|---|---|---|
| Message Type | | | |
| Length | | | |
| AP(210)/APC(220) Job ID | | | |
| IE Name | T | L | Value |
| Code | | | |
| PKM Identifier | | | |
| Attributes | | | |

As set forth in Table 12 above, the AP 210 can request authentication-related information of the MSS 100 from the AP 220 via the Hbis-Security Request message.

When the AP 210 requests authentication-related information of the MSS 100, the Hbis-Security Request message may be one of an Authorization Request message, a Key Request message and an EAP(210) Transfer Request message.

Table 13a below shows parameters of the Authorization Request message.

TABLE 13a

| IE Name | | T | L | Value |
|---|---|---|---|---|
| SS-Certificate | | | | X.509 User Certificate |
| Security- | CryptogrAP(210)hic | | | Allowed cryptogrAP(210)hic suites Data |
| CAP(210)abilities | Suite List | | | encryption algorithm identifier (e.g., CBC- |
| | | | | Mode) Data authentication algorithm |
| | | | | identiferTEK encryption algorithm identifier |
| | | | | (e.g., RSA) |

| | |
|---|---|
| Version | Version of PKM security |
| SAI | Primary SAID (Basic CID) |

Table 13b shows parameters of the Key Request message.

TABLE 13b

| IE Name | T | L | Value |
|---|---|---|---|
| EAP(210) Payload | | | Described in RFC2284bis |

In addition, Table 13c below shows parameters of the EAP(210) Transfer Request message.

TABLE 13c

| IE Name | T | L | Value |
|---|---|---|---|
| CA-Certificate | | | X.509 User Certificate |

In S48, the APC 220, upon receiving the Hbis-Security Request message, exchanges authentication-related parameter information with the server 500 according to an EAP(210) mode in order to process subscriber authentication of the MSS 100.

In an exemplary implementation, the server 500 may comprises an ASA server.

In S49, the APC 220 stores authentication-related information exchanged with the ASA server 500, and generates and transmits an Hbis-Security Response message to the AP 210.

The Hbis-Security Response message may be one of an Authorization Response message, a Key Response message and an EAP(210) Transfer Response message.

Table 14 below shows parameters of the Hbis-Security Response message that the APC 220 transmits.

TABLE 14

| IE Name | T | L | Value |
|---|---|---|---|
| Code | | | |
| PKM Identifier | | | |
| Attributes | | | |

As set forth Table 14 above, the APC 220 can transmit authentication-related parameter information via the Hbis-Security Response message.

Table 14a below shows parameters of the Authorization Response message.

TABLE 14a

| IE Name | | T | L | Value |
|---|---|---|---|---|
| AUTH-Key | | | | 128-byte quantity |
| | | | | representing as RSA- |
| | | | | encrypted AK |
| Key-Lifetime | | | | |
| Key-Sequence-Number | | | | |
| SA- | SAID | | | |
| Descriptor | SA-Type | | | Primary, Static, Dynamic |
| | CryptogrAP(210)hic- | | | |
| | Suite | | | |

Table 14b below shows parameters of the Key Response message.

TABLE 14b

| | | | |
|---|---|---|---|
| IE Name | T | L | Value |

| Key-Sequence-Number | | |
|---|---|---|
| SAID | | |
| TEK | TEK | Encrypted with the KEK |
| Parameters | Key-Lifetime | TEK Remaining Lifetime |
| | Key-Sequence- | TEK Sequence Number |
| | Number | |
| | CBC-IV | CBC Initialization Vector |

Table 14c below shows parameters of the EAP Transfer Response message.

TABLE 14c

| IE Name | T | L | Value |
|---|---|---|---|
| EAP(210) Payload | | | Described in FRC2284bis |

In S50, the AP 210 stores authentication-related parameters contained in the received Hbis-Security Response message, generates a Privacy Key Management Response (PKM-RSP) message according to each message type, and transmits the PKM-RSP message to the MSS 100.

In S51, when authentication process is completed, the MSS 100 transmits an Registration Request (REG-REQ) message containing service and CS-related CAP(210)ability information, ARG parameter and registration information such as information about whether or not a management mode is supported to the AP 210.

The AP 210, upon receiving the REG-REG message, allocates a Secondary Management CID to the MSS 100, and generates and transmits an Hbis-Registration Request message to the APC, requesting registration information in S52.

Table 15 below shows parameters of the Hbis-Registration Request message that the AP 210 transmits.

TABLE 15

| Name | Description | | |
|---|---|---|---|
| Message Type | | | |
| Length | | | |
| AP(210)/APC(220) Job ID | | | |
| Secondary Management CID | | | |
| GRE Tunnel Key | (for Secondary Management CID) | | |
| IP Address | | | |
| IE Name | T | L | Value |

| | |
|---|---|
| Uplink CID Support | The number of Uplink CIDs the PSS can |
| | support |
| SS Management Support | Whether or not the PSS is managed |
| IP Management Mode | |
| IP Version | |

| | |
|---|---|
| SS | ARQ support |
| Capabilities | DSx flow control |
| Encoding | MAC CRC support |
| | MCA flow control |
| | Multicast polling group CID |
| | support |
| | PKM flow control |
| | Authorization policy support |
| | Maximum number of |
| | supported SAs |

Vendor ID Encoding
Vendor-specific Information

| | | |
|---|---|---|
| CS | CS (Convergence Sublayer) | |
| CAP(210) | support | |
| abilities | Maximum number of | |
| | classifiers | |
| | PHS support | |
| ARQ | ARQ Enable | |
| Parameters | ARQ_WINDOW_SIZE | |
| | ARQ_RETRY_TIMEOUT | The sum of Transmitter Delay and |
| | | Receiver Delay |
| | ARQ_BLOCK_LIFETIME | |
| | ARQ_SYNC_LOSS | |
| | ARQ_DELIVER_IN_ORDER | |
| | ARQ_PURGE_TIMEOUT | |
| | ARQ_BLOCK_SIZE | |

| | |
|---|---|
| Method for allocating IP address | DHCP, Mobile Ipv4, DHCPv6, Ipv6 |
| | Stateless Address Auto-configuration |
| Mobility features supported | Mobility(Handoff), Sleep-mode, Idle- |
| | mode support |
| Sleep-mode recovery time | |

As set forth in Table 15 above, the AP 210 can request registration information of the MSS 100 to the APC 220 via the Hbis-Registration Request message.

In S53, the APC 220, upon receiving the Hbis-Registration Request message, acquires subscriber profile about the MSS 110 from the server 500.

In S54, the APC 220 makes a reply via an Hbis-Registration Response message containing result about requested registration information and GRE Tunnel Key and IP address about Secondary Management CID.

Table 16 below shows parameters of the Hbis-Registration Response message that the APC 220 transmits.

TABLE 16

| Name | Description | | |
|---|---|---|---|
| Message Type | | | |
| Length | | | |
| AP/APC Job ID | | | |
| GRE Tunnel Key | (for Secondary Management CID) | | |
| IP Address | AP/APC IP address (for Secondary | | |
| | Management CID) | | |
| IE Name | T | L | Value |

| | |
|---|---|
| Response | |
| SS Management Support | Whether or not the PSS is managed |
| IP Management Mode | |
| IP Version | |

| | |
|---|---|
| SS | ARQ support |
| Capabilities | DSx flow control |
| Encoding | MAC CRC support |
| | MCA flow control |
| | Multicast polling group CID |
| | support |
| | PKM flow control |
| | Authorization policy support |
| | Maximum number of |
| | supported SAs |

Vendor ID Encoding (of the responder)
Vendor-specific Information

| | | |
|---|---|---|
| CS | CS (Convergence Sublayer) | |
| CAP(210) | support | |
| abilities | Maximum number of | |
| | classifiers | |
| | PHS support | |
| ARQ | ARQ Enable | |
| Parameters | ARQ_WINDOW_SIZE | |
| | ARQ_RETRY_TIMEOUT | The sum of Transmitter Delay and |
| | | Receiver Delay |
| | ARQ_BLOCK_LIFETIME | |
| | ARQ_SYNC_LOSS | |
| | ARQ_DELIVER_IN_ORDER | |
| | ARQ_PURGE_TIMEOUT | |
| | ARQ_BLOCK_SIZE | |

Method for allocating IP address
Mobility features supported

As set forth in Table 16 above, the APC 220 can transmit registration information to the MSS 100 via the Hbis-Registration Response message.

In S55, the AP 210 generates a Registration Response (REG-RSP) message containing result about registration information of in the Hbis-Registration Response message and Secondary Management CID, and transmits the REG-RSP message to the MSS 100.

Where the MSS 100 supports Subscriber Station (SS) and IP Management modes, it is possible to additionally acquire IP address and parameter information necessary for management so that management can be processed in an IP management mode.

A Dynamic Host Configuration Protocol (DHCP) process is performed in order to acquire IP address necessary for the MSS 100 to exchange packets to provide a service.

In S56, the APC 220, upon receiving the Hbis-Service Add Request message, processes negotiation with the policy server 500 according to QoS policy information about subscribers.

After having allocated Transport CID to the MSS 100, the APC 220 transmits an Hbis-Service Add Request message to the AP 210 in S57. The Hbis-Service Add Request message contains SF/CS parameters, GRE Tunnel Key information necessary for packet tunneling between the AP 210 and the APC 220 and IP address information.

In S58, the AP 210 transmits a Dynamic Service Addition Request (DSA-REQ) message containing SF/CS parameter information in order to set a call for packet exchange.

Table 17 below shows the Hbis-Service Add Request message that the AP 210 transmits.

TABLE 17

| Name | | Description | | |
|---|---|---|---|---|
| Transaction ID | | | | |
| GRE Tunnel Key | | Traffic Tunnel Key between AP(210) | | |
| | | and APC(220) | | |
| IP Address | | (AP/APC) IP address (for Tunnel) | | |
| IE Name | | T | L | Value |
| Service | Service Flow Identifier (SFID) | | | |
| Flow | Transport CID | | | |
| Parameters | Service Class name | | | |
| | QoS Parameter Set Type | | | Provisioned Set, Admitted Set, Active |
| | | | | Set |
| | Traffic Priority | | | |
| | Maximum Sustained Traffic Rate | | | |
| | Maximum Traffic Burst | | | |
| | Minimum Reserved Traffic Rate | | | |
| | Minimum Tolerable Traffic Rate | | | |
| | Service Flow Scheduling Type | | | |
| | Request/Transmission Policy | | | |
| | Tolerated Jitter | | | |
| | Maximum Latency | | | |
| | Fixed-length versus Variable- | | | Used only if packing is on for the |
| | length SDU Indicator | | | service flow |
| | SDU Size | | | |
| | Target SAID | | | |
| | ARQ TLVs for ARQ-enabled | | | |
| | connection | | | |
| CS | CS Specification | | | IPv4, IPv4 over 802.3, ATM, etc |
| Parameter | Classifier rule priority | | | The priority for the Classifier |
| Encodings | IP TOS/DSCP range and mask | | | |
| | Protocol | | | Protocol field in IP header |
| | IP masked source address | | | IP addresses and their corresponding |
| | | | | address masks |
| | IP destination address | | | |
| | Protocol source port range | | | |
| | Protocol destination port range | | | |
| | Ethernet destination MAC address | | | |
| | Ethernet source MAC address | | | |
| | Ethertype/IEEE802.2-1998 | | | |
| | SAP(210) | | | |
| | IEEE 802.1D-1998 User_Priority | | | |
| | IEEE 802.1A-1998 VLAN_ID | | | |
| | Associated PHSI | | | |
| | Packet Classifier Rule Index | | | |
| | Vendor-specific classifier | | | |
| | parameters | | | |
| | PHS DSC action | | | |
| | PHS error parameter set | | | |
| | PHS Rule | | | PHSI, PHSF, PHSM, PHSS, PHSV |
| | IPv6 Flow label | | | |

As set forth in Table 17 above, the AP 210 can request SF and CS parameters necessary for providing a service to the MSS 100 via the Hbis-Service Add Request message.

In S59, the MSS 100 transmits Confirmation Code information and SF/CS parameter result value contained in the Hbis-Service Add Response message via a Dynamic Service Addition Response (DSA-RSP) message.

In S60, the AP 210 generates and transmits an Hbis-Service Add Response message to the APC 220. The Hbis-Service Add Response message contains Confirmation Code information, requested SF/CS parameter result value, GRE Tunnel Key information for packet tunneling between the AP 210 and the APC 220 and IP address information.

Table 18 below shows parameters of the Hbis-Service Add Response message that the AP 210 transmits.

TABLE 18

| Name | Description | | |
|---|---|---|---|
| Transaction ID | | | |
| GRE Tunnel Key | Traffic Tunnel Key between AP and APC | | |
| IP Address | (AP/APC) IP address (for Tunnel) | | |
| IE Name | T | L | Value |

Confirmation Code

| | | |
|---|---|---|
| Service | Service Flow Identifier (SFID) | Present in BS-initiated DSx-REQ and in |
| Flow | | its DSx-RSP to PSS-initiated DSx-REQ |
| Parameters | Transport CID | |
| | Service Class name | |
| | QoS Parameter Set Type | Provisioned Set, Admitted Set, Active |
| | | Set |
| | Traffic Priority | |
| | Maximum Sustained Traffic Rate | |
| | Maximum Traffic Burst | |
| | Minimum Reserved Traffic Rate | |
| | Minimum Tolerable Traffic Rate | |
| | Service Flow Scheduling Type | |
| | Request/Transmission Policy | |
| | Tolerated Jitter | |
| | Maximum Latency | |
| | Fixed-length versus Variable- | |
| | length SDU Indicator | |
| | ARQ TLVs for ARQ-enabled | |
| | connection | |
| CS | CS Specification | IPv4, IPv4 over 802.3, ATM, etc |
| Parameter | Classifier rule priority | The priority for the Classifier |
| | IP TOS/DSCP range and mask | |
| | Protocol | Protocol field in IP header |
| | IP masked source address | IP addresses and their corresponding |
| | | address masks |
| | IP destination address | |
| | Protocol source port range | |
| | Protocol destination port range | |
| | Ethernet destination MAC address | |
| | Ethernet source MAC address | |
| | Ethertype/IEEE802.2-1998 SAP | |
| | IEEE 802.1D-1998 User_Priority | |
| | IEEE 802.1A-1998 VLAN_ID | |
| | Associated PHSI | |
| | Packet Classifier Rule Index | |
| | Vendor-specific classifier | |
| | parameters | |
| | PHS DSC action | |
| | PHS error parameter set | |
| | PHS Rule | PHSI, PHSF, PHSM, PHSS, PHSV |
| | IPv6 Flow label | |

As set forth in Table 18 above, the AP 210 can transmit Confirmation Code information and SF/CS parameter information via the Hbis-Service Add Response message.

In S61, the APC 220 generates and transmits an Hbis-Service Complete message to the AP 210 in order to notify the AP 210 of whether or not call setting is succeeded.

Table 19 below shows parameters of the Hbis-Service Complete message that the AP 210 transmits.

TABLE 19

| Name | Description |
|---|---|
| Message Type | |
| Length | |
| AP(210)/APC(220) Job ID | |
| Transaction ID | |
| Result (ACK/NACK) | |

As set forth in Table 19 above, the APC 220 can notify the AP 210 of whether or not call setting is succeeded via the Hbis-Service Complete message.

In S62, the AP 210 generates and transmits a Dynamic Service Addition Acknowledge (DSA-ACK) message to the MSS 100.

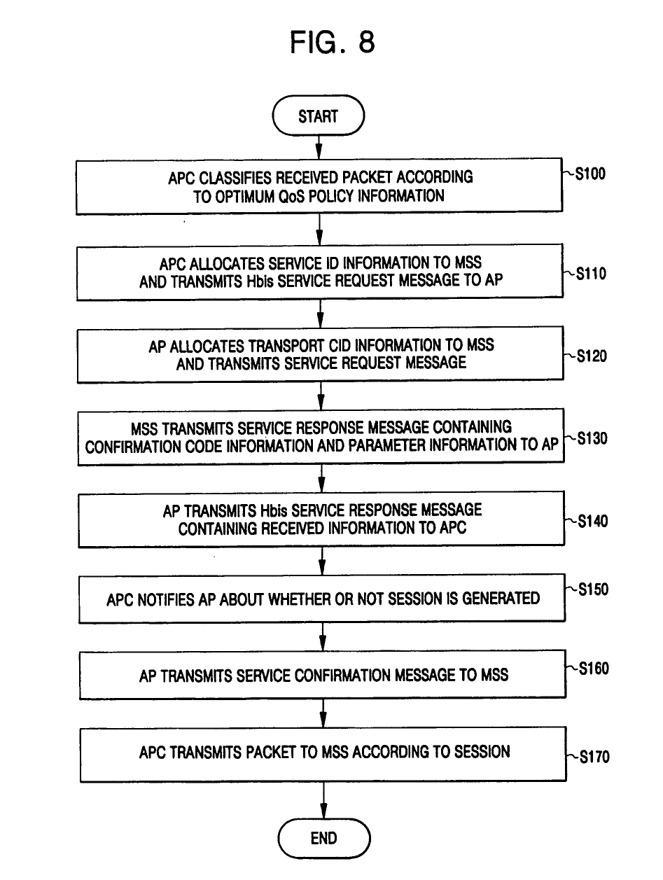

FIG. 8 is a flowchart for illustrating a message processing method in an Awake mode of a portable Internet system according to an exemplary embodiment of the present invention.

Referring to FIG. 8, in S100, when a packet to be transmitted to the MSS 100 is received from the IP network, the APC 220 classifies the received packet by confirming QoS policy information of the MSS 100.

In S110, the APC 220 allocate service ID information for packet transmission, and transmits an Hbis service request message to the AP 210 in order to set a session in use for packet transmission. The Hbis service request message contains SF/CS parameter information, GRE Tunnel Key information for packet tunneling with the AP 210 and IP address information.

In S120, the AP 210, upon receiving the Hbis service request message, allocates Transport CID information to the MSS, and transmits a service request message containing SF/CS parameter information to the MSS 100.

In S130, the MSS 100, upon receiving the service request message from the AP 210, transmits a service response message containing Confirmation Code information and requested SF/CS parameter result value to the AP 210.

In S140, the AP 210 transmits an Hbis service response message to the PAC 220. The Hbis service response message contains Confirmation Code information received from the MSS 100, requested SF/CS parameter result value, Tunnel Key information for packet tunneling between the AP 210 and the APC 220, IP address information and allocated transport CID information.

In S150, the APC 220 transmits an Hbis service confirmation message to the AP 210 in order to notify the PA 210 about whether or not a session for packet transmission is successfully set.

In S160, if session generation is confirmed via an internal service confirmation message, the AP transmits a service confirmation message to the MSS 100.

The APC 220 also transmits the received packet to the MSS 100 via the generated session in S170.

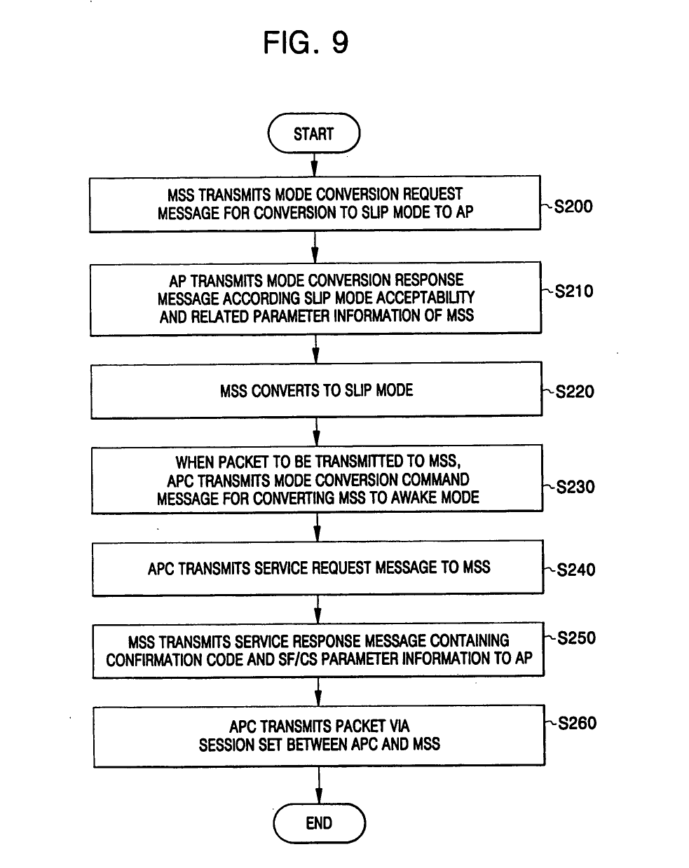

FIG. 9 is a flowchart for illustrating a message processing method in a Sleep mode of a portable Internet system according to an exemplary embodiment of the present invention.

Referring to FIG. 9, in S200, if packet exchange has not taken place for a predetermined time period, the MSS 100 transmits a mode conversion request message containing Sleep mode-related parameter information to the AP 210 in order to convert to a Sleep mode.

In S210, the AP 210, upon receiving the mode conversion request message from the MSS 100, transmits a mode conversion response message to the MSS 100. The mode conversion response message contains information about whether or not a Sleep mode is accepted and related parameter information.

Then, the session state of the MSS 100 is converted into a Sleep mode in S220.

When a packet to be transmitted to the MSS 100 is received in the session converted into the Sleep mode, the APC 220 classifies the packet according to optimum QoS policy information and allocates service ID information of the MSS 100 to the packet.

Also, the APC 220 transmits an Hbis service request message containing SF/CS parameter information, Tunnel Key information for packet tunneling with the AP 210 and IP information to the AP 210.

In S23, the AP 210, upon receiving the Hbis service request message from the APC 220, transmits a mode-conversion command message to convert the MSS 100 from a Sleep mode to an Awake mode.

In S240, the AP 210 allocates transport CID to the MSS 100, and transmits a service request message containing SF/CS parameter information to the MSS 100.

Upon receiving the service request message from the AP 210, the MSS 100 transmits a service response message containing Confirmation Code and requested SF/CS parameter result value to the AP 210 in S250.

In S260, the AP 210 transmits a message containing received Confirmation Code, requested SF/CS parameter result value, Tunnel Key information for packet tunneling with the APC 220, IP address information and allocated transport CID information to the APC 220, and the APC 220 generates a session for transmitting a packet to the MSS 100.

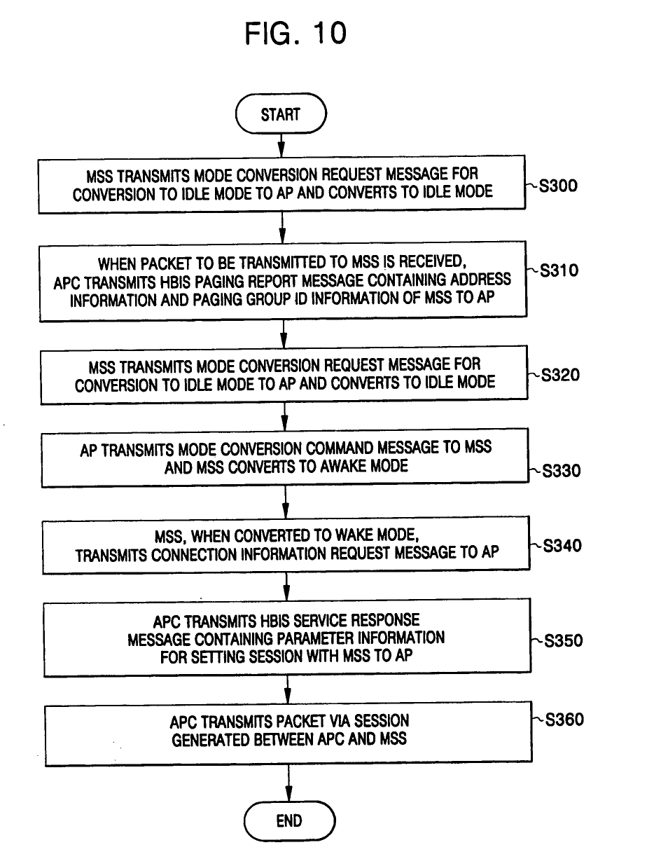

FIG. 10 is a flowchart for illustrating a message processing method in an Idle mode of a portable Internet system according to a preferred embodiment of the invention.

Referring to FIG. 10, in S300, if packets have not been exchanged for a predetermined time period, the MSS 100 transmits a mode conversion request message to the AP 210 to convert to an Idle mode.

In S310, when a packet to be transmitted to the MSS 100 is received from the IP network, the APC 220, transmits an Hbis paging report message containing MAC address information and Paging Group ID information of the MSS 100 to the AP 210.

Since the MSS 100 is in the Idle mode, the AP 100 transmits a mode conversion command message to convert the session state of the MSS 100 to an Awake mode in S320.

In S330, when converted to the Awake mode, the MSS 100 transmits a message requesting MAC address information and connection information to the AP 210 via initial Ranging CID.

In S340, the AP 210 transmits an Hbis service request message to the APC 220, for setting a session for transmitting a packet to the MSS 100.

Upon receiving the Hbis service request message, the APC 220 acquires parameter information for setting a session with the MSS 100 and transmits this parameter information to the AP 210 via an Hbis service response message in S350.

In S360, the AP 210 sets a session with the MSS 100 according to received parameter information, and APC 220 transmits the packet according to the session set between the AP 210 and the MSS 100.

As described hereinbefore, exemplary embodiments of the present invention makes it possible to increase the number of MSSs 100 that a single base station 200 can provide a service as well as to efficiently manage information by which a service can be provided to each MSS 100.

While exemplary embodiments of the present invention have been shown and described in connection with the exemplary implementations thereof, it will be understood by those skilled in the art that modifications and variations can be made without departing from the spirit and scope of the present invention as defined by the following claims.

What is claimed is:

1. A packet processing method in a portable Internet system comprising at least one terminal, the method comprising steps of:
transmitting session information to a corresponding connection processor upon receiving a packet from a network;
setting session with the terminal according to the session information, and transmitting the session setup information to the connection controller; and
transmitting the packet to the terminal via a session generated according to the session setup information.

2. The packet processing method according to claim 1, wherein the session information comprises at least one of: Confirmation Code information, Service Flow (SF) ID information, Convergence Sublayer (CS) information, transport CID information, tunnel key information and IP address information.

3. The packet processing method according to claim 1, further comprising:
confirming service quality policy information of the terminal from a policy server upon receiving the packet; and
classifying the packet according to the service quality policy information and allocating service ID to the terminal.

4. A packet processing method in a portable Internet system comprising at least one terminal, the method comprising steps of:
transmitting a traffic indication message to the connection processor upon receiving packet on the session state of sleep mode;
transmitting a mode conversion request message to the terminal upon receiving the traffic message;
converting session state to Awake mode upon receiving the mode conversion request message;
transmitting session information to a corresponding connection processor;
setting session with the terminal according to the session information, and transmitting the packet through the session generated.

5. The packet processing method according to claim 4, wherein the session information comprises at least one of: Confirmation Code information, Service Flow (SF) ID information, Convergence Sublayer (CS) information, transport CID information, tunnel key information and IP address information.

6. A packet processing method in a portable Internet system comprising at least one terminal, the method comprising steps of:
transmitting a paging message containing paging-related information to the terminal via the connection processor upon receiving a packet in the idle mode of the terminal;
converting to an awake mode upon receiving the paging message, and transmitting a connection information request message to the connection processor;
allocating basic CID information and Primary Management CID information of the terminal, and setting basic capability information;
providing registration information according to authentication procedure and subscriber information of the terminal;
transmitting session information to a corresponding connection processor; and
setting session with the terminal according to the session information, and transmitting the packet through the session generated.

7. The packet processing method according to claim 6, wherein the session information comprises at least one of: Confirmation Code information, Service Flow (SF) ID information, Convergence Sublayer (CS) information, transport CID information, tunnel key information and IP address information.

8. A portable Internet system for providing Internet service to plurality of terminals comprising:
a connection controller adapted to, upon receiving a packet from a network, confirm service quality information of the terminal, classify the packet, transmit session information, and transmit the packet to the terminal via a session generated according to the session setup information; and
at least one connection processor adapted to set a session with the terminal according to the session information from the connection controller and transmit the session setup information to the connection controller.

9. The portable Internet system according to claim 8, wherein the connection processor is adapted to manage slip mode information of the terminal that is wirelessly connected.

10. The portable Internet system according to claim 8, wherein the connection controller is adapted to manage idle mode information of the terminal, and if a destination terminal of the packet is in an idle mode, transmit paging-related information to the destination terminal via the connection processor.

11. The portable Internet system according to claim 8, wherein the connection processor comprises:
a physical layer;
an encryption layer for processing PDU authentication and encryption;
a media access control(MAC) Protocol Data Unit (PDU) processing layer for forming a PDU by using a MAC header and a MAC subheader;
a MAC scheduling layer for processing packet-scheduling; and
a wireless link control layer for allocating key information and connection ID information, transmitting connection information to the connection controller, and receiving registration information from the connection controller.

12. The portable Internet system according to claim 8, wherein the connection controller comprises:
an Automatic Repeat Request (ARQ) block layer for exchanging a subheader with the connection controller in order to process ARQ;
a Packet header Suppression layer for compressing a packet header;
a packet classification layer for classifying the packet and mapping the packet according to a service flow;
a security management layer for managing privacy key information;
a connection control layer for allocating tunnel key information and service flow ID information and receiving connection information from the connection processor;
a network gateway layer for processing packet authentication and allowing packet reception from the network; and
a mobility management layer for supporting the mobility of the terminal.

13. A packet processing method in a portable Internet system, which comprises at least one terminal, at least one connection processor and a connection controller internally connected with the connection processor, the method comprising steps of:
transmitting to the connection processor an Hbis-Service Add Request message containing Service Flow (SF) information, Convergence Sublayer (CS) parameter information, Key information and IP address information upon receiving packet;
allocating transport CID information to the terminal upon receiving the Hbis-Service Add message, and transmitting a Dynamic Service Addition Request (DSA-REQ) message containing SF information and CS parameter information to the terminal;
transmitting a Dynamic Service Addition Response(DSA-RSP) message containing Confirmation Code information to the connection processor upon receiving the DSA-REQ message;
transmitting an Hbis-Service Add Response containing Confirmation Code information, SF information, CS parameter result value, Key information, IP address information and transport CID information to connection controller;
transmitting an Hbis-Service Confirm message in order to notify whether or not generation of a session to the connection processor;
transmitting a Dynamic Service Addition Acknowledge (DSA-ACK) message in order to notify whether or not session generation is succeeded to the terminal upon receiving the Hbis-Service Confirm message;
transmitting the packet to the terminal via the generated session if the generation is succeeded.
